(19) United States
(12) Patent Application Publication
(10) Pub. No.: US 2024/0194934 A1
(43) Pub. Date: Jun. 13, 2024

(54) SOLID ELECTROLYTE COMPOSITION FOR TRIPLE-DOPED GARNET-TYPE ALL-SOLID-STATE BATTERY, SOLID ELECTROLYTE FOR TRIPLE-DOPED GARNET-TYPE ALL-SOLID-STATE BATTERY USING SAME, AND METHOD FOR PREPARING SAME

(71) Applicant: THE INDUSTRY & ACADEMIC COOPERATION IN CHUNGNAM NATIONAL UNIVERSITY (IAC), Daejeon (KR)

(72) Inventors: Hai Minh Nguyen, Daejeon (KR); Sangbaek Park, Daejeon (KR)

(21) Appl. No.: 18/196,058

(22) Filed: May 11, 2023

(30) Foreign Application Priority Data
Dec. 12, 2022 (KR) 10-2022-0172814

(51) Int. Cl. H01M 10/0562; H01M 10/0525

(52) U.S. Cl. CPC H01M 10/0562; H01M 10/0525; H01M 2300/0071

(57) ABSTRACT

The present disclosure relates to a solid electrolyte composition for a triple-doped garnet-type all-solid-state battery, a solid electrolyte for a triple-doped garnet-type all-solid-state battery using the same, and a method for preparing the solid electrolyte for a triple-doped garnet-type all-solid-state battery and, more particularly, to a solid electrolyte composition for a triple-doped garnet-type all-solid-state battery, comprising a Li-based compound, a La-based compound, and a Zr-based compound, and comprising an Al-based compound, a Ga-based compound, and a Ta-based compound for doping, a solid electrolyte for a triple-doped garnet-type all-solid-state battery, using the solid electrolyte composition for a triple-doped garnet-type all-solid-state battery, and a method for preparing the solid electrolyte for a triple-doped garnet-type all-solid-state battery.

### BACKGROUND

### Field

The present disclosure claims the benefit of the filing date of Korean Patent Application No. 10-2022-0172814, filed with the Korean Intellectual Property Office on Dec. 12, 2022, all of which are included in the present disclosure. The present disclosure relates to a solid electrolyte composition for a triple-doped garnet-type all-solid-state battery, a solid electrolyte for a triple-doped garnet-type all-solid-state battery using the same, and a method for preparing the solid electrolyte for a triple-doped garnet-type all-solid-state battery and, more particularly, to a solid electrolyte composition for a triple-doped garnet-type all-solid-state battery, comprising a Li-based compound, a La-based compound, and a Zr-based compound, and comprising an Al-based compound, a Ga-based compound, and a Ta-based compound for doping, a solid electrolyte for a triple-doped garnet-type all-solid-state battery, which contains Li, La, and Zr, and is doped with Al, Ga, and Ta, and a method for preparing the solid electrolyte for a triple-doped garnet-type all-solid-state battery.

### Related Art

Lithium ion batteries (LIBs) have been commercialized and widely applied to various energy storage systems such as electric transportation and portable electronic devices. Lithium ion batteries having a Li-rich liquid electrolyte exhibit high lithium ionic conductivities. However, several serious safety issues can arise during charging and discharging, such as uncontrolled exothermic reactions, self-ignition, or chemical leakage due to excessive charging and internal short circuits. Currently, all-solid-state lithium-ion batteries (ASSLIBs) containing a solid electrolyte are promising candidates that will replace conventional lithium-ion batteries in terms of wide application in different power sources with low risk and high reliability. The all-solid-state lithium-ion batteries exhibit excellent characteristics such as high safety, high power density, low chemical leakage, long cycle life, and low self-charging rate compared to lithium-ion batteries.

To date, extensive research for preparing and developing various types of solid electrolytes having relatively high Li-ion conductivities has been conducted. Among them, Li-garnet type Li₇La₃Zr₂O₁₂ (LLZO) has been widely studied due to various advantages such as high ionic conductivity, good thermal stability, excellent chemical stability to Li metal, and wide ranges of operating temperatures and voltages. LLZO includes two stable forms of a cubic phase and a tetragonal phase. The cubic phase LLZO exhibits a higher ionic conductivity (about 104 S·cm⁻¹ at room temperature) when it is compared to the tetragonal phase LLZO (about 106 S·cm⁻¹ at room temperature). Therefore, for high performance all-solid-state lithium-ion batteries, it is essential to fabricate LLZO with a high ratio of the cubic phase. In order to obtain cubic phase LLZO with a very high conductivity, several studies have attempted to extend the sintering time (typically 24 hours or more) in a temperature range of 1,000 to 1,200° C. For the optimal performance of LLZO, extensive investigations related to Li site and Zr site doping were performed on a small number of trivalent cations (Ga³⁺, Al³⁺) and supervalent cations (Ta⁵⁺, Bi⁵⁺, Nb⁵⁺, Sb⁵⁺), respectively, thereby improving the Li-ion conductivity of LLZO by stabilizing the highly conductive phase (cubic phase) and increasing the Li vacancy concentration. Each dopant plays a specific role in modifying the characteristics of LLZO by stabilizing the cubic phase. For example, Al doping at Li⁺ sites increases Li vacancies in the crystal structure to stabilize the cubic phase, and Al addition aids sintering to improve the density of pellets. Ga doping has an effect similar to Al substitution, but it can stabilize the cubic phase of LLZO at a low sintering temperature of about 1,000° C., and some previous studies have pointed out that Ga-doped LLZO exhibits a relatively high Li-ion conductivity compared to other doping elements of Li⁺ sites. In addition, Ta substitution at the Zr site stabilizes the highly conductive cubic phase. Furthermore, Ta substitution, as in Al doping, will not hinder Li ion migration, and Ta is stable compared to Li. However, systematic studies of the effect of multiple doping on phase content or ionic conductivity for LLZO are still rare and difficult to understand. In addition, a large loss of Li occurs during the sintering process for a long time, and secondary phases such as La₂Zr₂O₇ are formed so that the ionic conductivity of LLZO is reduced. In order to prevent loss of Li during preparation, it is necessary to carefully control the initial concentration of Li, and a short sintering process at an appropriate temperature should be considered.

### SUMMARY

A technical problem to be achieved by the present disclosure is to provide a solid electrolyte composition for a triple-doped garnet-type all-solid-state battery through triple doping and appropriate control of the initial Li⁺ concentration, a solid electrolyte for a triple-doped garnet-type all-solid-state battery, having excellent ionic conductivity and high relative density, and a method for preparing the solid electrolyte for a triple-doped garnet-type all-solid-state battery.

However, the problems to be solved by the present disclosure are not limited to the above-mentioned problem, and other problems not mentioned will be clearly understood by those skilled in the art from the description below.

One embodiment of the present disclosure provides a solid electrolyte composition for a triple-doped garnet-type all-solid-state battery, which comprises a Li-based compound, a La-based compound, and a Zr-based compound, and comprises an Al-based compound, a Ga-based compound, and a Ta-based compound for doping.

According to one embodiment of the present disclosure, the Li-based compound included in the Li-based compound, the La-based compound, and the Zr-based compound may have a mole fraction of 0.57 or more and 0.63 or less.

One embodiment of the present disclosure provides a method for preparing a solid electrolyte for a triple-doped garnet-type all-solid-state battery, the method comprising: a mixing step of preparing a mixture by mixing a solid electrolyte composition for a triple-doped garnet-type all-solid-state battery; a calcination step of calcining the mixture; and a pulverization step of pulverizing the calcined mixture to prepare a pulverized material.

According to one embodiment of the present disclosure, the method may further comprise: a compression step of compressing the pulverized material to form it into pellets; and a sintering step of sintering the pellets.

According to one embodiment of the present disclosure, the calcination step may be performing heat treatment at a temperature of 800° C. or more and 1,000° C. or less for 1 hour or more and 10 hours or less.

According to one embodiment of the present disclosure, the pulverization step may be performing plane surface ball milling at a speed of 200 rpm or more and 500 rpm or less.

According to one embodiment of the present disclosure, the pulverized material may have an average particle size of 0.5 μm or more and 3 μm or less.

According to one embodiment of the present disclosure, the compression step may have a pressure of 100 MPa or more and 300 MPa or less.

According to one embodiment of the present disclosure, the sintering step may be performing heat treatment at a temperature of 1,100° C. or more and 1,300° C. or less for a time of 30 minutes or more and 50 minutes or less.

One embodiment of the present disclosure provides a solid electrolyte for a triple-doped garnet-type all-solid-state battery, which contains Li, La, and Zr and is doped with Al, Ga, and Ta.

According to one embodiment of the present disclosure, the solid electrolyte for the all-solid-state battery may have a structure of Formula 1 below.

LiₐAl_{b}Ga_{c}La₃Zr_{d}TaₑO₁₂ [Formula 1]

in Formula 1, 5.5≤a≤8.0, 0.18≤b≤0.24, 0.06≤c≤0.08, 1.75≤d≤1.90, and 0.01≤e≤0.02.

According to one embodiment of the present disclosure, the solid electrolyte for the all-solid-state battery may have an ionic conductivity of 3.0×10⁻⁴ S·cm⁻¹ or more and 5.0×10⁻⁴ S·cm⁻¹ or less.

According to one embodiment of the present disclosure, the solid electrolyte for the all-solid-state battery may contain a cubic phase and a tetragonal phase, wherein the cubic phase is contained in an amount of 75% by weight or more and 85% by weight or less.

According to one embodiment of the present disclosure, the solid electrolyte for the all-solid-state battery may have a relative density of 97% or more calculated by Equation 1 below.

Relative density (%)=real density of solid electrolyte for triple-doped garnet-type all-solid-state battery/theoretical density of solid electrolyte for triple-doped garnet-type all-solid-state battery [Equation 1]

According to one embodiment of the present disclosure, the solid electrolyte for the all-solid-state battery may be a powder-type or pellet-type solid electrolyte for a triple-doped garnet-type all-solid-state battery.

The solid electrolyte for a triple-doped garnet-type all-solid-state battery can be prepared within a short sintering time through a method for preparing a solid electrolyte for a triple-doped garnet-type all-solid-state battery, comprising triple doping (Al/Ga/Ta) and control of initial Li⁺ concentration according to one embodiment of the present disclosure.

The solid electrolyte for a triple-doped garnet-type all-solid-state battery according to one embodiment of the present disclosure may have high ionic conductivity and high relative density even with a short sintering time.

### BRIEF DESCRIPTION OF THE DRAWINGS

FIG. 1 is a flowchart of a method for preparing a solid electrolyte for a triple-doped garnet-type all-solid-state battery, which is one embodiment of the present disclosure.

FIGS. 2A and 2B show XRD patterns of an Al-doped LLZO powder (FIG. 2A) and an Al/Ga/Ta-doped LLZO powder (FIG. 2B) after a ball milling process, which is a pulverization step according to one embodiment of the present disclosure, at different rotational speeds.

FIGS. 3A and 3B show XRD Rietveld refinement results of an Al-doped LLZO powder (FIG. 3A) and an Al/Ga/Ta-doped LLZO powder (FIG. 3B) after a ball milling process, which is a pulverization step according to one embodiment of the present disclosure, at different rotational speeds.

FIGS. 4A, 4B, 4C, 4D, and 4E show SEM images of a triple (Al/Ga/Ta)-doped LLZO powder after a ball milling process, which is a pulverization step according to one embodiment of the present disclosure, at different rotational speeds (0 rpm in FIG. 4A, 200 rpm in FIG. 4B, 300 rpm in FIG. 4C, 400 rpm in FIG. 4D, and 500 rpm in FIG. 4E).

FIGS. 5A and 5B are XRD patterns of an Al-doped LLZO powder (FIG. 5A) and an Al/Ga/Ta-doped LLZO powder (FIG. 5B) having different initial Li concentrations after a ball milling process, which is a pulverization step, under optimized conditions (200 rpm, 2 h) according to one embodiment of the present disclosure.

FIGS. 6A, 6B, 6C, 6D, 6E, and 6F are XRD Rietveld refinement results of an Al-doped LLZO powder and an Al/Ga/Ta-doped LLZO powder having different initial Li concentrations after a ball milling process, which is a pulverization step, under optimized conditions (200 rpm, 2 h) according to one embodiment of the present disclosure (Al_6.9 in FIG. 6A, AGT_6.9 in FIG. 6B, Al_7.7 in FIG. 6C, AGT_7.7 in FIG. 6D, Al_8.4 in FIG. 6E, and AGT_8.4 in FIG. 6F).

FIGS. 7A and 7B show XRD patterns of sintered Al-doped LLZO pellets (FIG. 7A) and Al/Ga/Ta-doped LLZO pellets (FIG. 7B) having different initial Li concentrations according to one embodiment of the present disclosure.

FIGS. 8A, 8B, 8C, 8D, 8E, and 8F are XRD Rietveld refinement results of sintered Al-doped LLZO pellets and Al/Ga/Ta-doped LLZO pellets having different initial Li concentrations according to one embodiment of the present disclosure (Al_6.9 in FIG. 8A, AGT_6.9 in FIG. 8B, Al_7.7 in FIG. 8C, AGT_7.7 in FIG. 8D, Al_8.4 in FIG. 8E, and AGT_8.4 in FIG. 8F).

FIGS. 9A and 9B show changes in cubic phase concentrations in samples having two types of doping and different initial Li concentrations according to one embodiment of the present disclosure (powder in FIG. 9A and pellets in FIG. 9B).

FIGS. 10A, 10B, 10C, 10D, 10E, and 10F are SEM images of cross-sectional shapes of sintered pellets having different initial Li concentrations according to one embodiment of the present disclosure (Al_6.9 in FIG. 10A, AGT_6.9 in FIG. 10B, Al_7.7 in FIG. 10C, AGT_7.7 in FIG. 10D, Al_8.4 in FIG. 10E, and AGT_8.4 in FIG. 10F).

FIG. 11 is digital images of sintered pellets having different initial Li concentrations according to one embodiment of the present disclosure.

FIGS. 12A and 12B show changes in Li ion concentrations of calcined powder (FIG. 12A) and sintered pellets (FIG. 12B) according to one embodiment of the present disclosure.

FIGS. 13A, 13B, 13C, and 13D show EIS curves of Al-doped LLZO pellets (FIG. 13A) and triple (Al/Ga/Ta)-doped LLZO pellets (FIG. 13B) having different initial Li contents and Nyquist plots of Al-doped LLZO pellets (FIG. 13C) and triple (Al/Ga/Ta)-doped LLZO pellets (FIG. 13D) having different initial Li contents according to one embodiment of the present disclosure.

FIG. 14A shows ionic conductivities and relative densities of pellets having different initial Li concentrations according to one embodiment of the present disclosure.

FIG. 14B is Arrhenius plots of an Al-doped sample (Al_7.7) and a triple (Al/Ga/Ta)-doped sample (AGT_7.7) according to one embodiment of the present disclosure.

FIGS. 15A and 15B are EIS results of an Al-doped sample (FIG. 15A) and a triple (Al/Ga/Ta)-doped sample (FIG. 15B) having an initial Li concentration of 7.7 mol when the samples according to one embodiment of the present disclosure have different temperatures.

FIG. 16 is Nyquist plots of Al-doped LLZO (Al_7.7), Ga-doped LLZO (Ga_7.7), Al/Ga-doped LLZO (AG_7.7), and Al/Ga/Ta-doped LLZO (AG_7.7) having an initial Li concentration of 7.7 mol according to one embodiment of the present disclosure.

FIG. 17 summarizes a comparison list of rapidly sintered LLZO pellets according to one embodiment of the present disclosure.

FIG. 18 shows a Nyquist plot of Al-doped LLZO which has an initial Li content of 7.7 mol and is prepared by performing sintering for 24 hours according to one embodiment of the present disclosure.

### DESCRIPTION OF EXEMPLARY EMBODIMENTS

In the present specification, when a certain part “includes” a certain component, this means that other components may be further included without excluding other components unless otherwise stated.

In the present specification, “A and/or B” means “A and B, or A or B”.

In the present specification, “A_X” may mean LLZO doped with X mol of element A, and “A/B_X” may mean LLZO doped with X mol of element A and element B.

In the present specification, “garnet-type” may mean including both a cubic phase and a tetragonal phase, respectively.

Hereinafter, the present disclosure will be described in more detail.

One embodiment of the present disclosure is a solid electrolyte composition for a triple-doped garnet-type all-solid-state battery, which comprises a Li-based compound, a La-based compound, and a Zr-based compound, and comprises an Al-based compound, a Ga-based compound, and a Ta-based compound for doping.

In the solid electrolyte composition for a triple-doped garnet-type all-solid-state battery according to one embodiment of the present disclosure, a cubic phase is present to be predominant over a tetragonal phase. Specifically, it can be confirmed that the solid electrolyte composition for the garnet-type all-solid-state battery has a cubic phase of 73.7% and 72.9%, respectively, in Al doping and triple (Al/Ga/Ta) doping.

According to one embodiment of the present disclosure, a solid electrolyte composition for a triple-doped garnet-type all-solid-state battery comprises a Li-based compound, a La-based compound, and a Zr-based compound. The Li-based compound may include a lithium-based carbide (Li₂CO₃) and a lithium-based hydrate (LiOH). The La-based compound may include a lanthanum-based oxide (La₂O₃) and a lanthanum-based hydrate (La(OH)₃). The Zr-based compound may include a zirconium-based oxide (ZrO₂).

According to one embodiment of the present disclosure, a solid electrolyte composition for a triple-doped garnet-type all-solid-state battery may comprise an Al-based compound, a Ga-based compound, and a Ta-based compound for doping. The Al-based compound may include an aluminum oxide (Al₂O₃). The Ga-based compound may include a gallium-based oxide (Ga₂O₃). The Ta-based compound may include a tantalum-based oxide (Ta₂O₅).

According to one embodiment of the present disclosure, the Li-based compound included in the Li-based compound, the La-based compound, and the Zr-based compound in the solid electrolyte composition for a triple-doped garnet-type all-solid-state battery may have a mole fraction of 0.57 or more and 0.63 or less. Specifically, the chemical formula of the solid electrolyte composition for a triple-doped garnet-type all-solid-state battery was Li₇₋₃ₐ(AlGa)ₐLa₃Zr_{2-b}Ta_{b}O₁₂, wherein a was fixed to 0.25, and b was fixed to 0.018. At this time, the molar ratio of the Li-based compound, the La-based compound, and the Zr-based compound was Li:La:Zr=6.25:3:2, and this was used as a standard. Raw materials of the Li-based compound, La-based compound, and Zr-based compound have a Li:La:Zr molar ratio of x:3:2, and when the x value is 6.9, 7.7, and 8.4, 10.4%, 23.2%, and 34.4% of excess Li may be contained, respectively, compared to when the x value is 6.25. For example, when the x value is 6.9, 6.9/6.25=110.4%, and 10.4% of excess Li will be contained, when the x value is 7.7, 7.7/6.25=123.2, and 23.2% of excess Li will be contained, and when the x value is 8.4, 8.4/6.25=134.4%, and 34.4% of excess Li will be contained. Therefore, if the mole fraction of the Li-based compound is calculated as x/(x+3+2) using the Li:La:Zr molar ratio of x:3:2, and x values of 6.9, 7.7, and 8.4 are substituted, the Li-based compound will have a mole fraction value of 0.57 or more and 0.63 or less. In this way, triple doping is possible by containing the Li-based compound in an excessive amount of 10% to 35%. In addition, it is possible to prepare a solid electrolyte for a garnet-type all-solid-state battery having excellent ionic conductivity by comprising the Li-based compound in an excessive amount of 10% to 35%, and thus reducing Li loss occurring in the calcination step and the sintering step.

According to one embodiment of the present disclosure, the mole fraction of the Li-based compound included in the Li-based compound, the La-based compound, and the Zr-based compound in the solid electrolyte composition for a triple-doped garnet-type all-solid-state battery may satisfy [Equation a] and [Equation b].

Mole of Li-based compound:mole of La-based compound:mole of Zr-based compound=x:3:2 [Equation a]

0.57≤x/(x+3+2)≤0.63 [Equation b]

One embodiment of the present disclosure is a method for preparing a solid electrolyte for a triple-doped garnet-type all-solid-state battery, which comprises: a mixing step of preparing a mixture by mixing the solid electrolyte composition for a triple-doped garnet-type all-solid-state battery; a calcination step of calcining the mixture; and a pulverization step of pulverizing the calcined mixture to prepare a pulverized material.

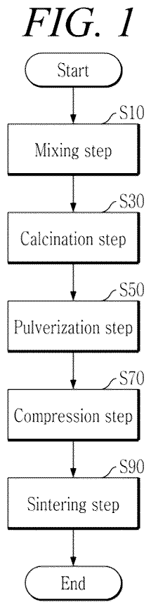

FIG. 1 is a flowchart of a method for preparing a solid electrolyte for a triple-doped garnet-type all-solid-state battery, which is one embodiment of the present disclosure. Referring to FIG. 1, a method for preparing a solid electrolyte for a triple-doped garnet-type all-solid-state battery, which is one embodiment of the present disclosure, will be described in detail.

According to one embodiment of the present disclosure, the method may further comprise: a compression step of compressing the pulverized material to form it into pellets; and a sintering step of sintering the pellets.

According to one embodiment of the present disclosure, the mixing step (S10) of preparing a mixture by mixing the solid electrolyte composition for a triple-doped garnet-type all-solid-state battery may be a step of mixing a sample of chemical formula Li_{x-0.75}Al_{0.172}Ga_{0.072}La₃Zr_{1.982}Ta_{0.018}O₁₂ comprising the Li-based compound, the La-based compound, and the Zr-based compound, and comprising an Al-based compound, a Ga-based compound, and a Ta-based compound for doping using ball milling. Specifically, the mixing step (S10) may be mixing the sample in ethanol (concentration: 99.9% by weight) at 250 rpm for 6 hours using planetary ball milling.

According to one embodiment of the present disclosure, the calcination step (S30) of calcining the mixture may be performing heat treatment at a temperature of 800° C. or more and 1,000° C. or less for 1 hour or more and 10 hours or less. Preferably, the calcination step (S30) may be performing heat treatment at a temperature of 850° C. or more and 950° C. or less for 5 hours or more and 7 hours or less. Specifically, the powder sample obtained through the mixing step (S10) may be dried and then calcined at 900° C. for 6 hours to obtain an initial stage of LLZO.

According to one embodiment of the present disclosure, the pulverization step (S50) of pulverizing the calcined mixture to prepare a pulverized material may be performing plane surface ball milling at a speed of 200 rpm or more and 500 rpm or less. Preferably, the pulverization step (S50) may be performing plane surface ball milling at a speed of 200 rpm or more and 300 rpm or less for 1 hour or more and 3 hours or less. Specifically, since a decrease in the cubic phase and an increase in the tetragonal phase are shown when the rotational speed of the ball milling process, which is the pulverization step, is increased, a powder sample obtained through the calcination step (S30) may be plane surface-ball milled at a speed of 200 rpm for 2 hours in order to optimize the quality of the mother powder (composition) for pellet production.

According to one embodiment of the present disclosure, the pulverized material obtained through the pulverization step (S50) may have an average particle size of 0.5 μm or more and 3 μm or less. Preferably, the pulverized material may have an average particle size of 0.7 μm or more and 1.7 μm or less. In the case of pellets manufactured using particles larger than 3 μm, performing sintering at low energies alone is not sufficient to completely sinter the particles, whereas performing sintering at high energies can lead to porous grain boundaries between large particles, which can be advantageous for the growth of lithium dendrites, leading to short circuits in cells.

According to one embodiment of the present disclosure, the compression step (S70) of compressing the pulverized material to form it into pellets may be to manufacture pellets by applying a pressure to the pulverized material obtained through the pulverizing step (S50). The pressure applied to the pulverized material in the compression step (S70) may be 100 MPa or more and 300 MPa or less. Preferably, the compression step (S70) may be performing compression at a pressure of 200 MPa. When performing compression at the above pressure in the compression step (S70), it is possible to prepare a high energy density electrolyte since the energy density increases.

According to one embodiment of the present disclosure, the sintering step (S90) of sintering the pellets may be heat-treating the pellets manufactured in the compression step (S70) at a temperature of 1,100° C. or more and 1,300° C. or less for a time of 30 minutes or more and 50 minutes or less. Specifically, the sintering step (S90) may be covering the pellets with the same mother powder (composition) and heat-treating the pellets covered with the same mother powder (composition) at 1,250° C. for 40 minutes in a MgO crucible. In order to prevent volatilization of lithium in the solid electrolyte due to exposure to high temperatures for a long time, the pellets are covered with the same mother powder (composition) and heat-treated.

One embodiment of the present disclosure is a solid electrolyte for a triple-doped garnet-type all-solid-state battery, which contains Li, La, and Zr, and is doped with Al, Ga, and Ta.

According to one embodiment of the present disclosure, the solid electrolyte for the all-solid-state battery may have a chemical structure of LiₐAl_{b}Ga_{c}La₃Zr_{d}TaₑO₁₂ (5.5≤a≤8.0, 0.18≤b≤0.24, 0.06≤c≤0.08, 1.75≤d≤1.90, and 0.01≤e≤0.02). For example, the solid electrolyte for the all-solid-state battery may have a chemical structure of Li_{6.46}Al_{0.21}Ga_{0.07}La₃Zr_{1.83}Ta_{0.02}O₁₂, Li_{5.66}Al_{0.23}Ga_{0.08}La₃Zr_{1.77}Ta_{0.02}O₁₂, Li_{6.98}Al_{0.23}Ga_{0.07}La₃Zr_{1.88}Ta_{0.02}O₁₂, Li_{6.47}Al_{0.22}Ga_{0.07}La₃Zr_{1.82}Ta_{0.02}O₁₂, Li_{7.95}Al_{0.23}Ga_{0.07}La₃Zr_{1.85}Ta_{0.02}O₁₂, or Li_{6.75}Al_{0.19}Ga_{0.06}La₃Zr_{1.79}Ta_{0.01}O₁₂.

According to one embodiment of the present disclosure, the solid electrolyte for the all-solid-state battery may have an ionic conductivity of 3.0×10⁻⁴ S·cm⁻¹ or more and 5.0×10⁻⁴ S·cm⁻¹ or less. Specifically, the solid electrolyte for the all-solid-state battery having a chemical structure of Li_{6.47}Al_{0.22}Ga_{0.07}La₃Zr_{1.82}Ta_{0.02}O₁₂ may have an ionic conductivity of 3.6×10⁻⁴ S·cm⁻¹ or more.

According to one embodiment of the present disclosure, the solid electrolyte for the all-solid-state battery contains a cubic phase and a tetragonal phase, and the cubic phase may be contained in an amount of 75% by weight or more and 85% by weight or less. Specifically, the cubic phase may be contained in an amount of about 79.8% by weight in the solid electrolyte for the all-solid-state battery having a chemical structure of Li_{6.47}Al_{0.22}Ga_{0.07}La₃Zr_{1.82}Ta_{0.02}O₁₂.

According to one embodiment of the present disclosure, the solid electrolyte for the all-solid-state battery may have a relative density of 97% or more calculated by Equation 1 below.

Relative density (%)=real density of solid electrolyte for triple-doped garnet-type all-solid-state battery/theoretical density of solid electrolyte for triple-doped garnet-type all-solid-state battery [Equation 1]

Preferably, the relative density may be 97% or more and 99% or less. Specifically, a solid electrolyte for an all-solid-state battery having a chemical structure of Li_{6.47}Al_{0.22}Ga_{0.07}La₃Zr_{1.82}Ta_{0.02}O₁₂ may have a relative density of 97.84%.

According to one embodiment of the present disclosure, the solid electrolyte for the all-solid-state battery may be in a powder or pellet form. A solid electrolyte for a triple-doped garnet-type all-solid-state battery which contains Li, La, and Zr and is doped with Al, Ga, and Ta may include a powder or pellet form, and ionic conductivity and relative density may be improved through compression and sintering steps.

Hereinafter, embodiments will be described in detail in order to explain the present disclosure in detail. However, embodiments according to the present disclosure can be modified in many different forms, and the scope of the present disclosure is not construed as being limited to the embodiments described below. The embodiments of the present specification are provided to more completely explain the present disclosure to a person having ordinary skill in the art.

### Preparation Example: Preparation of Solid Electrolyte for Triple-Doped Garnet-Type All-Solid-State Battery

Li₂CO₃ (KOJUNDO, 99.99%), La₂O₃ (KOJUNDO, 99.9%), ZrO₂ (KOJUNDO, 98%), Al₂O₃ nanoparticles (Sigma-Aldrich, particle size of less than 50 nm), Ga₂O₃ (KOJUNDO, 99.99%), and Ta₂O₅ (KOJUNDO, 99.99%) were used in the preparation of a solid electrolyte. Due to hygroscopicity of La₂O₃, the raw materials were heated at 900° C. for 12 hours and then pulverized to remove the absorbed moisture. The raw materials were weighed with an excess Li of 10.4%, 23.2%, and 34.4%, respectively, with x-values of 6.9, 7.7, and 8.4 at a Li:La:Zr molar ratio of x:3:2. In the case of LLZO doped with Al, a certain amount of Al₂O₃ powder was added in order to achieve 0.25 mol of Al in one unit formula of LLZO samples with different Li doping levels (Al_6.9, Al_7.7, and Al_8.4), and the theoretical formula was Li_{x-0.75}Al_{0.25}La₃Z₂O₁₂. In order to prepare triple-doped LLZO, Al₂O₃, Ga₂O₃, and Ta₂O₅ were added to obtain samples with a chemical formula of Li_{x-0.75}Al_{0.172}Ga_{0.072}La₃Zr_{1.982}Ta_{0.018}O₁₂, and these samples indicated initial Li⁺ concentrations (AGT_6.9, AGT_7.7, and AGT_8.4) as standard. All precursor materials were mixed in ethanol (concentration: 99.9% by weight) at 250 rpm for 6 hours by planetary ball milling, and after drying, the powder sample was calcined at 900° C. for 6 hours to obtain an initial stage of LLZO. The calcined powder was pulverized again at different rotational speeds (200, 300, 400, and 500 rpm) for 2 hours and compressed at a pressure of 200 MPa to manufacture pellets. The obtained pellets were covered with the same mother powder (composition) in a MgO crucible (sintering furnace) and sintered at 1,250° C. for 40 minutes to prepare samples. Finally, all pellet samples were polished and stored in a glove box.

### <Method for Measuring Physical Properties>

The phase compositions of all powder and pellet samples were analyzed through X-ray diffraction (XRD) analysis using a D8 ADVANCE instrument (BRUKER, Karlsruhe, Germany) with a Cu Kα radiation source (40 kV and 40 mA). In order to refine the crystal structure, the XRD Rietveld refinement method was applied using the High Score Plus computer program (Malvern Panalytical Ltd., Malvern, Malvern, UK). The morphological characteristics of the samples were analyzed using a field-emission scanning electron microscopy (FE-SEM) system (HITachi S-4800, Tokyo, Japan). The densities of the pellet samples were measured using the Archimedes method together with water. The elemental compositions of the samples were analyzed using inductively coupled plasma-atomic emission spectroscopy (ICP-AES, Avio500, Perkin-Elmer, Waltham, MA, USA). The average particle sizes (particle sizes) of the powder samples were measured using a laser scattering particle size analyzer (PSA, Helos KFS-MAGIC, Sympatec GmbH, Clausthal-Zellerfeld, Germany). The ionic conductivities of all pellet samples were measured in the frequency range of 1 Hz to 10 MHz using an impedance spectrometer (IVIUM potentiostat/galvanostat, IVIUM technologies, Eindhoven, The Netherlands). Both mirror-polished surfaces of all pellet samples were coated with a silver paste (resistivity: ˜ 104 (2 cm), and then connected to an impedance spectrometer through an electric wire. Ionic conductivity measurements were performed at various temperatures (25° C. to 80° C.).

### Experimental Example: Result Interpretation

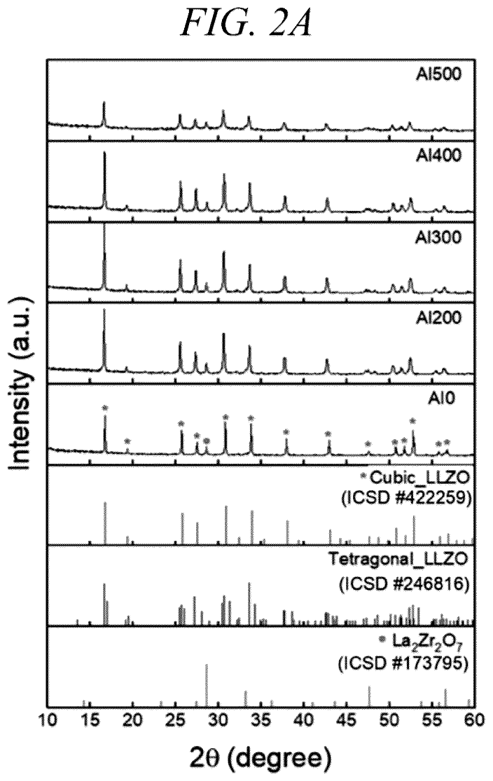

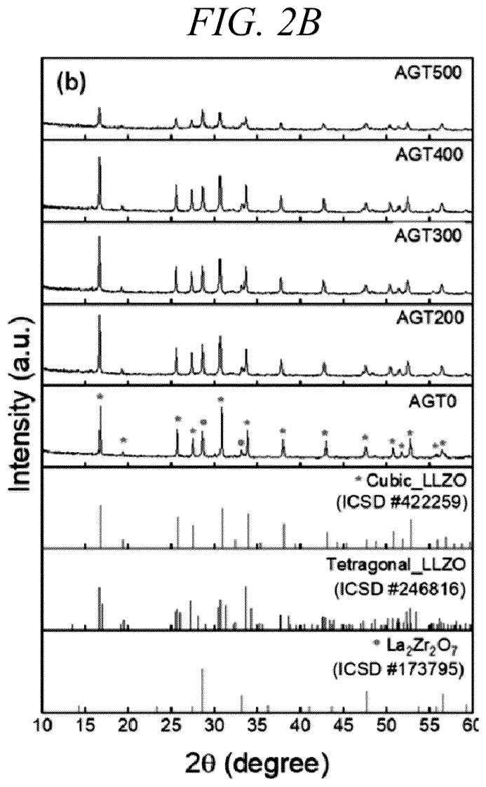

In order to optimize the quality of these powders for pellet production, the effect of ball milling conditions in the pulverization step on the structural and morphological characteristics of the mother powder was investigated. For such an optimization, two types of doped LLZO with an initial Li⁺ concentration of 6.9 mol were used. FIGS. 2A and 2B show XRD patterns of an Al-doped LLZO powder (FIG. 2A) and an Al/Ga/Ta-doped LLZO powder (FIG. 2B) after a ball milling process, which is a pulverization step, at different rotational speeds. Table 1 below shows the average particle sizes of the triple (Al/Ga/Ta)-doped LLZO powder according to different rotational speeds.

TABLE 1

| | Calcination | Plane surface ball | Average |
|---|---|---|---|
| Sample | conditions | milling conditions | particle size |
| Al/Ga/Ta-doped | — | — | 1.03 μm |
| LLZO powder | 900° C./6 hours | — | 24.4 μm |
| (AGT_LLZO) | 900° C./6 hours | 200 rpm/2 hours | 1.66 μm |
| | 900° C./6 hours | 300 rpm/2 hours | 1.05 μm |
| | 900° C./6 hours | 400 rpm/2 hours | 1.12 μm |
| | 900° C./6 hours | 500 rpm/2 hours | 0.78 μm |

FIGS. 2A and 2B show XRD patterns of an Al-doped LLZO powder (FIG. 2A) and an Al/Ga/Ta-doped LLZO powder (FIG. 2B) after a ball milling process, which is a pulverization step according to one embodiment of the present disclosure, at different rotational speeds.

As shown in FIGS. 2A and 2B, the A10 (FIG. 2A) and AGT0 (FIG. 2B) powders which are without the ball milling process, which is the pulverization step, mainly showed typical peaks of the cubic phase, and this indicates that the cubic phase was dominant in both samples.

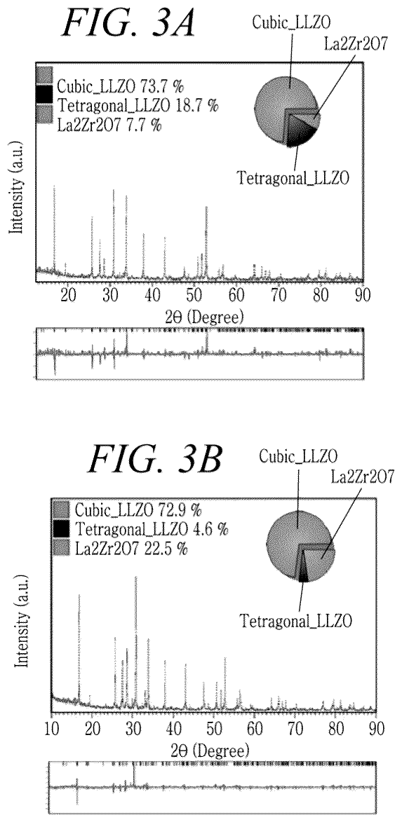

FIGS. 3A and 3B show XRD Rietveld refinement results of an Al-doped LLZO powder (FIG. 3A) and an Al/Ga/Ta-doped LLZO powder (FIG. 3B) after a ball milling process, which is a pulverization step according to one embodiment of the present disclosure, at different rotational speeds. Even in the XRD Rietveld refinement results of FIGS. 3A and 3B, it was confirmed that A10 and AGT0 had 73.7% and 72.9% of the cubic phase, respectively. Peaks with small 20 values at 28.6° and 33.3° correspond to the presence of La₂Zr₂O₇ (secondary phase) in the crystal structure, and this can be attributed to insufficient Li content and Li loss during fabrication. The XRD Rietveld refinement results also showed a tendency for the cubic phase to decrease and the tetragonal phase to increase when the rotational speed of the ball milling process, which is the pulverization step, was increased. This means that the pulverization step having high energy greatly affects the crystal structure of the mother powder (composition). In order to obtain cubic phase LLZO pellets from the mother powder (composition) with a low concentration cubic phase, higher energy (higher temperature and/or longer time) is required for the sintering step for increasing Li loss.

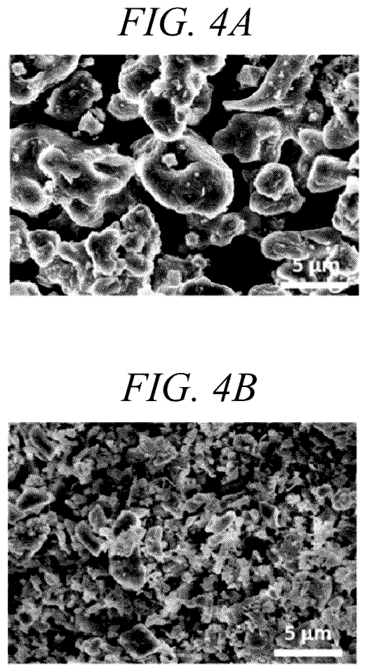

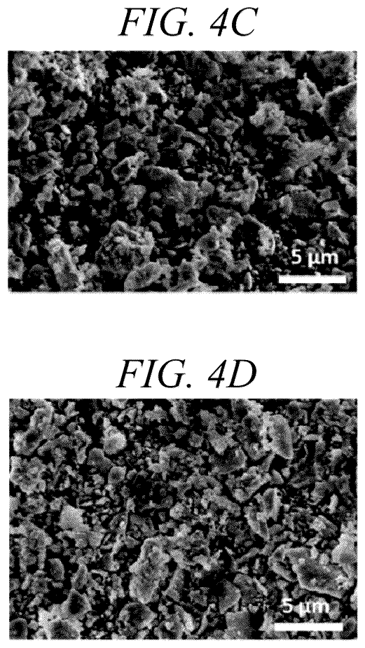

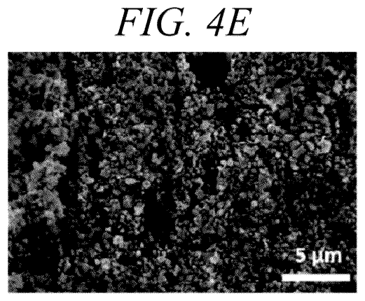

FIGS. 4A, 4B, 4C, 4D, and 4E are SEM images of a triple (Al/Ga/Ta)-doped LLZO powder after a ball milling process, which is a pulverization step according to one embodiment of the present disclosure (0 rpm in FIG. 4A, 200 rpm in FIG. 4B, 300 rpm in FIG. 4C, 400 rpm in FIG. 4D, and 500 rpm in FIG. 4E). As shown in Table 1 and FIGS. 4A, 4B, 4C, 4D, and 4E, the samples that did not go through a ball milling process, which is a pulverization step, showed much larger particle sizes than the samples after the pulverization step, whereas there was no significant difference in particle size between the powders subjected to the pulverization step. In the case of pellets manufactured using large particles, performing sintering at lower energies alone is not sufficient to completely sinter the particles, whereas performing sintering at higher energies can lead to porous grain boundaries between large particles, which can be advantageous for the growth of lithium dendrites, leading to short circuits in cells. Therefore, in the present disclosure, a low rotational speed of 200 rpm was selected as the ball milling condition of the pulverization step in order to optimize the quality of the mother powder (composition) for pellet production.

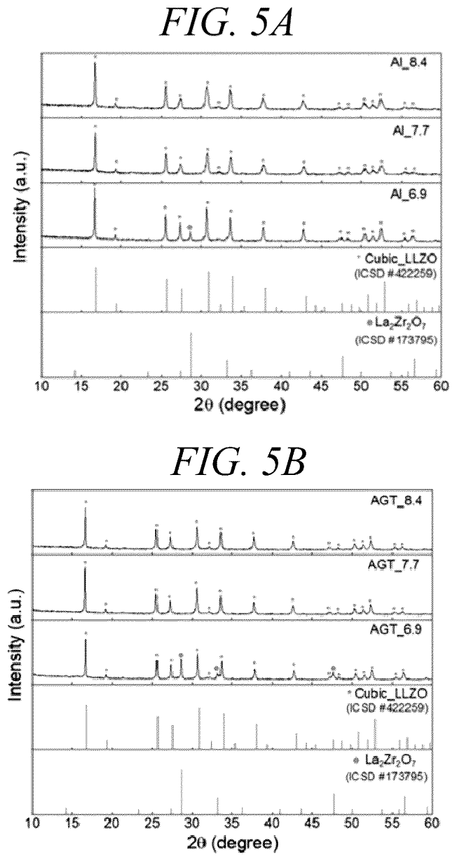

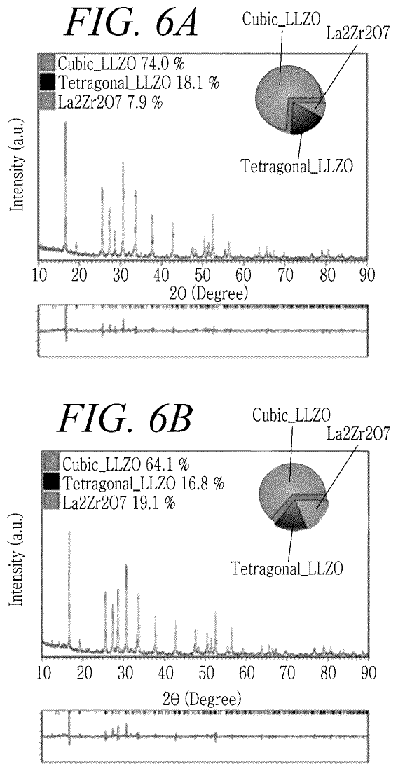

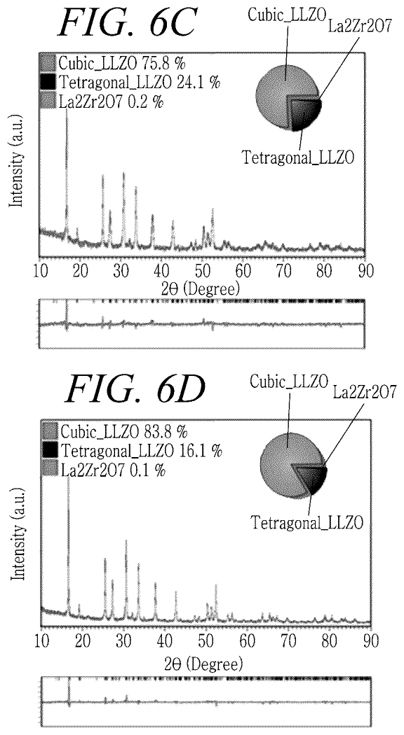

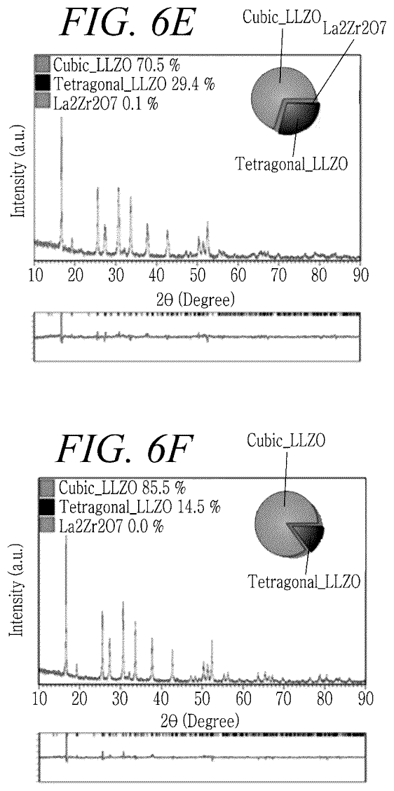

FIGS. 5A and 5B are XRD patterns of an Al-doped LLZO powder (FIG. 5A) and an Al/Ga/Ta-doped LLZO powder (FIG. 5B) having different initial Li concentrations after a ball milling process, which is a pulverization step, under optimized conditions (200 rpm, 2 h) according to one embodiment of the present disclosure. Referring to FIGS. 5A and 5B, the cube phase at a low Li content (x=6.9) is present in both of an Al-doped LLZO sample and an Al/Ga/Ta-doped LLZO sample along with a secondary phase (La₂Zr₂O₇) (additional peaks at 28.6° and 33.3°). The main concentrations of the cubic phase in the Al_6.9 and AGT_6.9 powder samples were determined to be 74% and 64.1%, respectively, using the XRD Rietveld refinement method (FIGS. 6A and 6B). The presence of the secondary phase (La₂Zr₂O₇) in the structure of these samples can be attributed to Li loss, and insufficient Li content to form cubic phase LLZO at this initial Li concentration. The conventional art reported that when the Al content is high (0.2 mol or more per LLZO formula unit), Al³⁺ ions can occupy non-Li cation sites as well as Li cation sites. Therefore, triple (Al/Ga/Ta)-doped LLZO with a small concentration of each element can replace Li⁺ sites more efficiently than LLZO doped with Al with a high content (0.25 mol) so that higher levels of Li substitution in AGT samples can be achieved after heat treatment at high temperatures. This was also confirmed in the ICP-AES results having a difference in Li content between the Al_6.9 sample and the AGT_6.9 sample. Table 2 below shows the results according to ICP-AES of the calcined mixture and the sintered pellets.

TABLE 2

| | | Atomic ratio | | | | |
|---|---|---|---|---|---|---|
| Sample | | Li | Zr | Al | Ga | Ta |
| Calcined | Al_6.9 | 6.77 | 1.86 | 0.31 | — | — |
| powder | Al_7.7 | 7.47 | 1.86 | 0.35 | — | — |
| | Al_8.4 | 7.90 | 1.85 | 0.34 | — | — |
| | AGT_6.9 | 6.46 | 1.83 | 0.21 | 0.07 | 0.02 |
| | AGT_7.7 | 6.98 | 1.88 | 0.23 | 0.07 | 0.02 |
| | AGT_8.4 | 7.95 | 1.85 | 0.23 | 0.07 | 0.02 |
| Sintered | Al_6.9 | 5.74 | 1.73 | 0.29 | — | — |
| pellets | Al_7.7 | 6.22 | 1.80 | 0.29 | — | — |
| | Al_8.4 | 6.75 | 1.83 | 0.22 | — | — |
| | AGT_6.9 | 5.66 | 1.77 | 0.22 | 0.08 | 0.02 |
| | AGT_7.7 | 6.47 | 1.82 | 0.22 | 0.07 | 0.02 |
| | AGT_8.4 | 6.75 | 1.79 | 0.19 | 0.06 | 0.01 |

FIGS. 6A, 6B, 6C, 6D, 6E, and 6F are XRD Rietveld refinement results of an Al-doped LLZO powder and an Al/Ga/Ta-doped LLZO powder having different initial Li concentrations after a ball milling process, which is a pulverization step, under optimized conditions (200 rpm, 2 h) according to one embodiment of the present disclosure (Al_6.9 in FIG. 6A, AGT_6.9 in FIG. 6B, Al_7.7 in FIG. 6C, AGT_7.7 in FIG. 6D, Al_8.4 in FIG. 6E, and AGT_8.4 in FIG. 6F).

As shown in FIGS. 6A, 6B, 6C, 6D, 6E, and 6F, as the initial Li concentrations increase (x=7.7 or 8.4), the secondary phase is not present in both of the Al-doped LLZO and AGT-doped LLZO powders, and the cubic phase becomes dominant. This means that the initial Li contents of 7.7 mol or more are sufficient for the formation of high-purity cubic phase LLZO.

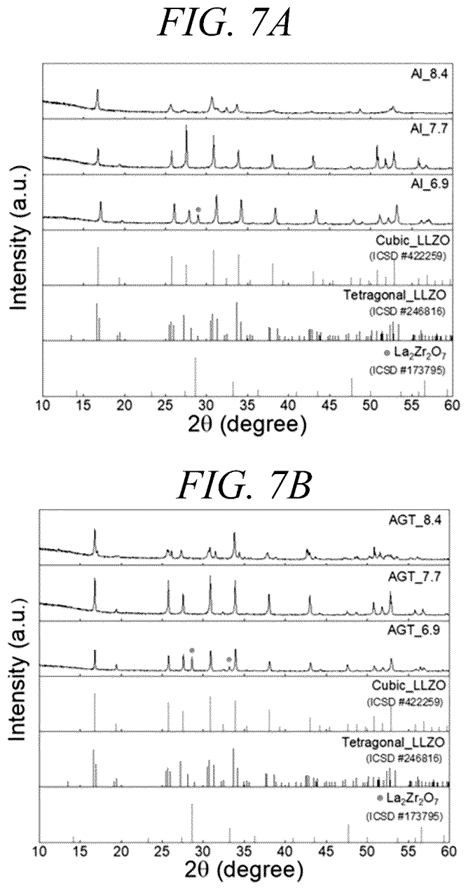

FIGS. 7A and 7B show XRD patterns of sintered Al-doped LLZO pellets (FIG. 7A) and Al/Ga/Ta-doped LLZO pellets (FIG. 7B) having different initial Li concentrations according to one embodiment of the present disclosure. Even after the sintering process, the Al_6.9 and AGT_6.9 pellet samples still contained most of the cubic phase, and some small peaks of the secondary phase (La₂Zr₂O₇) were also observed due to the low Li concentrations and loss of Li during sintering. When the initial Li contents are 7.7 mol, only a typical cubic phase diffraction peak presents in both of Al-doped LLZO and Al/Ga/Ta-doped LLZO pellets.

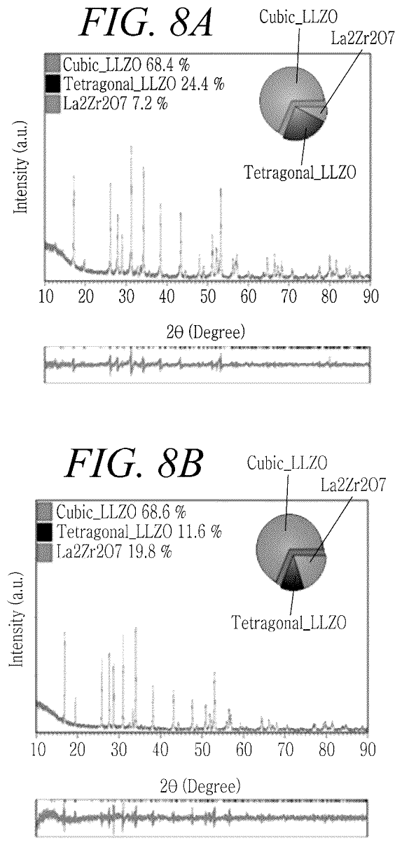

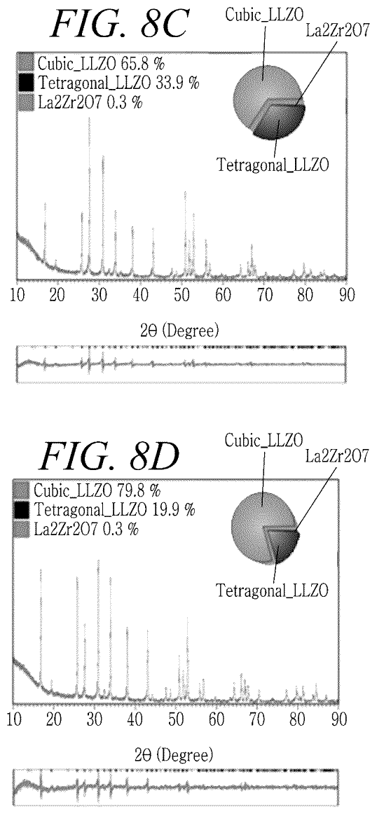

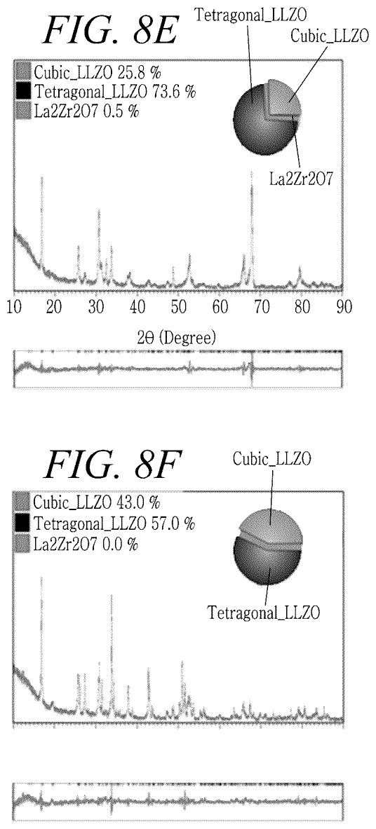

FIGS. 8A, 8B, 8C, 8D, 8E, and 8F are XRD Rietveld refinement results of sintered Al-doped LLZO pellets and Al/Ga/Ta-doped LLZO pellets having different initial Li concentrations according to one embodiment of the present disclosure (Al_6.9 in FIG. 8A, AGT_6.9 in FIG. 8B, Al_7.7 in FIG. 8C, AGT_7.7 in FIG. 8D, Al_8.4 in FIG. 8E, and AGT_8.4 in FIG. 8F). A phase transformation of the pellets from cubic phase LLZO to tetragonal phase LLZO is observed if the initial Li concentrations are increased from 7.7 mol to 8.4 mol (FIGS. 8C, 8D, 8E, and 8F), but all the mother powder samples corresponding to these Li contents have high quality at a state that the cubic phase is predominant. This may be due to distortion of the unit cell to accommodate additional charging of excess Li atoms at certain Li vacancy sites. These results suggest that the initial Li concentrations play a critical role in the formation of the final cube phase LLZO pellets, and that the initial Li contents should be optimized to the lower and upper limits at which the formation of the secondary phase and the transformation of the cube phase may occur, respectively.

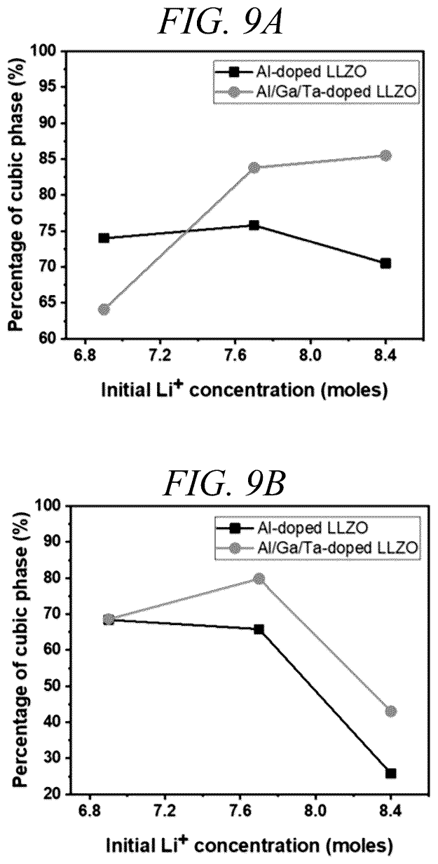

The phase compositions of all powder and pellet samples were analyzed using the XRD Rietveld refinement method, and FIGS. 9A and 9B show changes in cubic phase concentrations in samples having two types of doping and different initial Li concentrations according to one embodiment of the present disclosure.

As shown in FIG. 9A, in the case of the powder samples, the formation of a cubic phase in triple (Al/Ga/Ta)-doped LLZO is low due to the significant secondary phase when the initial Li content is low, and triple (Al/Ga/Ta)-doped LLZO shows a relatively high cubic phase content compared to Al-doped LLZO when the initial Li concentration is increased to 7.7 mol or more. In addition, as shown in FIG. 9B, triple (Al/Ga/Ta) doping promoted better cubic phase stability in LLZO than Al doping after sintering the pellets. As shown in FIGS. 8A, 8B, 8C, and 8D, as a result of XRD Rietveld refinement analysis, the cubic phase ratio rather increased from 68% to 80% in the case of triple (Al/Ga/Ta)-doped LLZO when the initial Li excess increased from 10.4% (AGT_6.9) to 23.2% (AGT_7.7), whereas the cube phase ratio decreased from 68% to 65% in the case of Al-doped LLZO when the initial Li excess increased from 10.4% (Al_6.9) to 23.2% (Al_7.7). As a result, sample AGT_7.7 (Li exceeding 23.2%) showed the highest cubic phase ratio, and this improved the formation and stability of the cubic phase in both of the powder and pellet samples by showing the advantage of optimized excess Li addition combined with triple doping (Al/Ga/Ta).

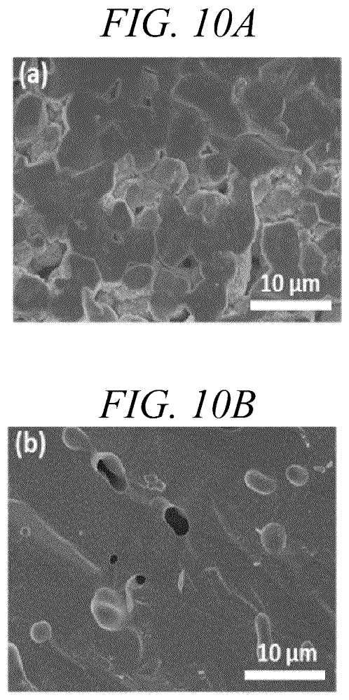

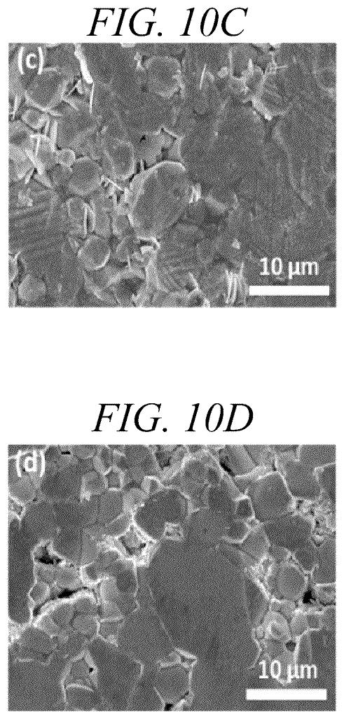

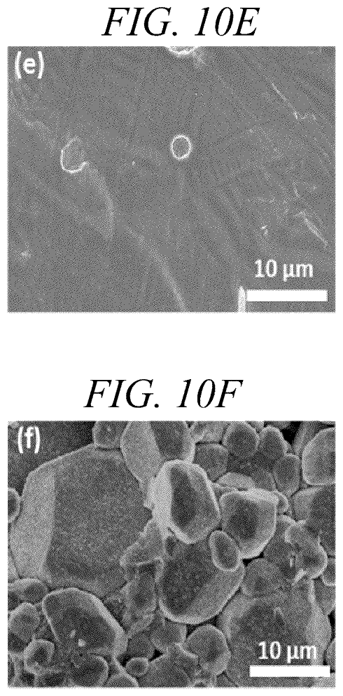

FIGS. 10A, 10B, 10C, 10D, 10E, and 10F are SEM images of cross-sectional shapes of sintered pellets having different initial Li concentrations according to one embodiment of the present disclosure (Al_6.9 in FIG. 10A, AGT_6.9 in FIG. 10B, Al_7.7 in FIG. 10C, AGT_7.7 in FIG. 10D, Al_8.4 in FIG. 10E, and AGT_8.4 in FIG. 10F).

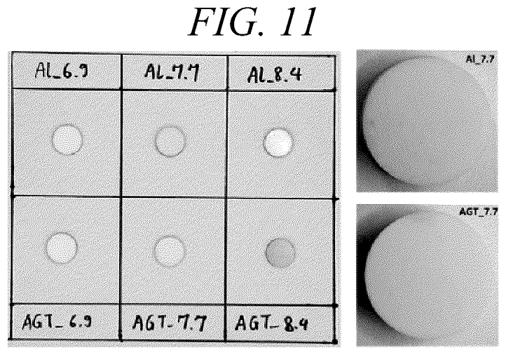

FIG. 11 is digital images of all pellets according to one embodiment of the present disclosure. At the optimized initial Li concentration (7.7 mol), both of Al-doped LLZO pellets and triple-doped LLZO pellets show smooth surfaces with small closed pores (FIGS. 10B and 10E), and this can result in low grain boundary (GB) resistances and thus improve the ionic conductivities of these pellets. On the other hand, much more grain boundaries (GB) are observed in other samples with high density. Many grain boundaries in samples with low and high Li contents contribute to lowering the ionic conductivity. Therefore, an appropriate initial Li concentration is important in order to ensure good sintering of the LLZO pellets.

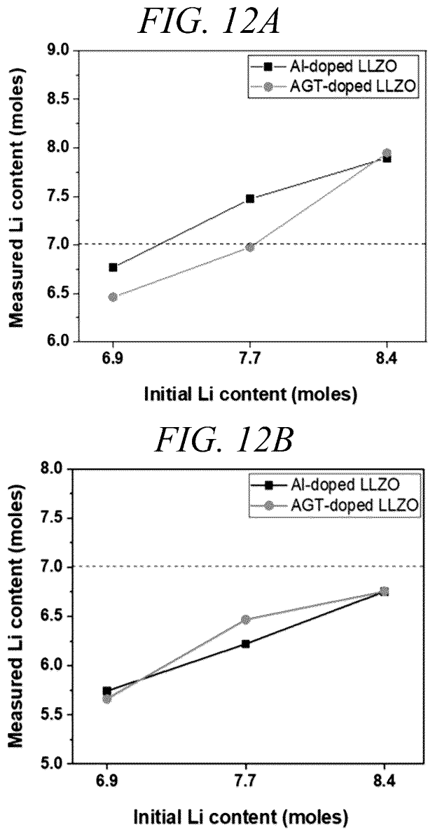

FIGS. 12A and 12B show changes in Li ion concentrations of calcined powder (FIG. 12A) and sintered pellets (FIG. 12B) according to one embodiment of the present disclosure.

Table 2 above shows the Li contents of Al-doped LLZO and triple (Al/Ga/Ta)-doped LLZO powders and sintered pellets analyzed by ICP-AES measurement. As shown in FIG. 12A and Table 2 above, all powders show a slight decrease in Li contents after performing calcination at 900° C. for 6 hours, and low Li concentrations observed in triple (Al/Ga/Ta)-doped LLZO powders compared to Al-doped LLZO powders with initial Li contents of 6.9 and 7.7 mols may be attributed to the more effective substitution of Li sites by appropriate amounts of Al, Ga, and Ta dopants rather than a high content of Al dopant alone. This means efficient doping of the Li site of the LLZO structure after calcination by introducing three elements (Al, Ga, and Ta) into the powders prepared at the above-described Li concentrations. In the powders with high initial Li contents (x=8.4), the continuous filling of Li in the LLZO structure from a large Li source hinders the doping of other elements to the Li sites, and thus there may not be caused a significant difference in the measured Li content between Al-doped and triple (Al/Ga/Ta)-doped powders. After sintering, all Li contents in the pellets further decreased to values less than 7 mol. This shows the presence of Li vacancies in all sintered pellets as shown in FIG. 12B, and this is advantageous in Li migration. The AGT_7.7 pellets show the lowest Li loss compared to the other samples, and this can be seen to be attributed to the effective sintering of less grain boundaries and small and closed pores. Based on these results, Li reduction during sintering can be greatly reduced through the synergistic effect of Li contents optimized with triple (Al/Ga/Ta) doping, making it ideal for high-temperature and long-term processes.

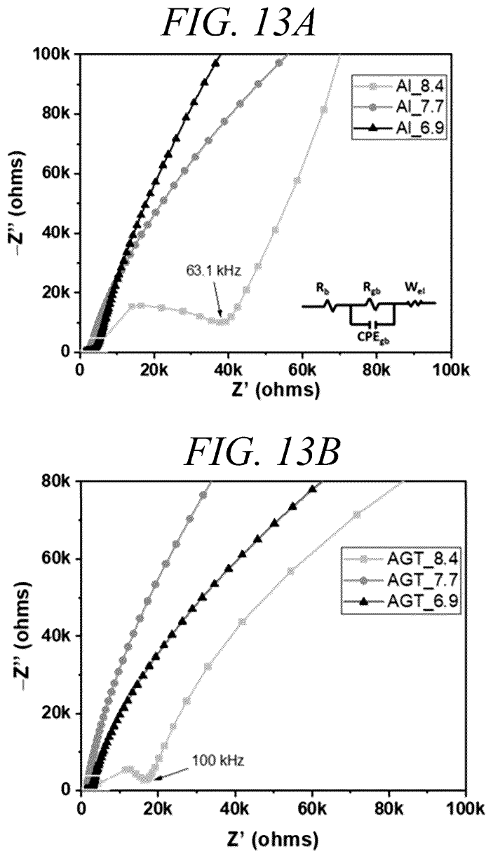

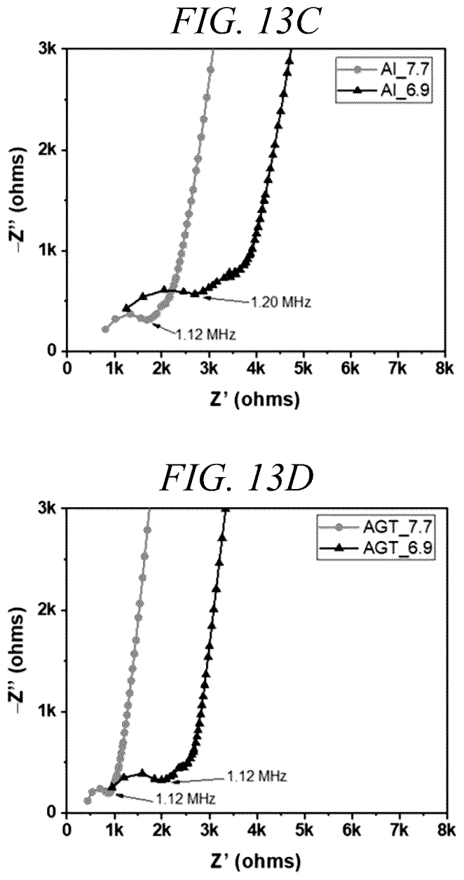

FIGS. 13A, 13B, 13C, and 13D show EIS curves of Al-doped LLZO pellets (FIG. 13A) and triple (Al/Ga/Ta)-doped LLZO pellets (FIG. 13B) having different initial Li contents and Nyquist plots of Al-doped LLZO pellets (FIG. 13C) and triple (Al/Ga/Ta)-doped LLZO pellets (FIG. 13D) having different initial Li contents according to one embodiment of the present disclosure. An equivalent circuit model (Rb (Rgb//CPEgb) Wel) is also presented in FIG. 13A, where Rb, Rgb, CPEgb, and Wel are bulk resistance, GB resistance, electrostatic phase element, and Warburg diffusion element, respectively

Al_8.4 and AGT_8.4 in FIGS. 13A and 13B show large GB impedance semicircles with terminal frequencies of about 63.1 and 100 kHz, respectively, whereas the other curves inside the dotted rectangles show much lower diameters.

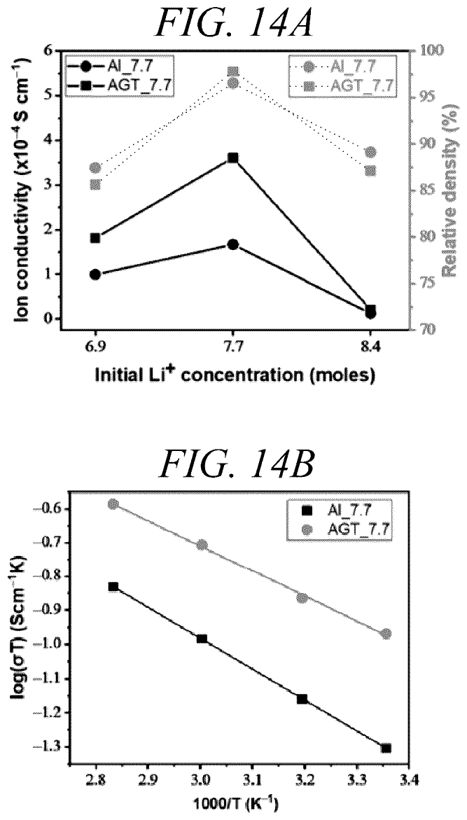

As shown in FIG. 13C and FIG. 13D, in the high-frequency views of the Nyquist plots, the Al_7.7 sample shows a smaller curve than the Al_6.9 sample, both semicircular curves correspond to GB resistances with terminal frequencies of 1.12 and 1.2 MHZ, respectively, and the mid- and low-frequency diffusion tails are assigned to the Warburg impedance. In the case of the AGT_7.7 and AGT_6.9 pellets, similar curves are observed, but the semicircles at higher frequencies have smaller diameters than the Al_7.7 and Al_6.9 samples. The conductivities and relative densities of the pellets are presented in Table 3 below and in FIG. 14A. Table 3 below shows the ionic conductivities and relative densities of the pellets with different initial Li concentrations.

TABLE 3

| Sample | Al_6.9 | Al_7.7 | Al_8.4 | AGT_6.9 | AGT_7.7 | AGT_8.4 |
|---|---|---|---|---|---|---|
| Ionic conductivity | 1.0 | 1.7 | 0.1 | 1.8 | 3.6 | 0.2 |
| (×10⁻⁴ S · cm⁻¹) | | | | | | |
| Relative density (%) | 87.47 | 96.55 | 89.14 | 85.65 | 97.84 | 87.14 |

FIG. 14A shows ionic conductivities and relative densities of pellets having different initial Li concentrations according to one embodiment of the present disclosure. The pellets with an initial Li concentration of 7.7 mol for each doping type show the highest conductivity values due to the high concentration of the conductive phase (cubic phase LLZO) without a secondary phase. Although the ratio of the cubic phase in the structure is high, the samples at low initial Li contents (x=6.9) exhibit lower Li-ion conductivities than the samples with optimized initial Li concentrations (x=7.7) due to the presence of the La₂Zr₂O₇ phase that is a secondary phase. When the initial Li contents are increased to 8.4 mol, the tetragonal phase becomes dominant in the crystal structure of the pellets due to phase transformation, resulting in a significant decrease in the ionic conductivities. Particularly, the AGT_7.7 sample had the most excellent ionic conductivity (3.6×10⁻⁴ S·cm⁻¹), whereas the Al_7.7 sample had an ionic conductivity of about 1.7×10⁻⁴ S·cm⁻¹ 1. In addition, at the same initial Li concentration, the other triple-doped (AGT-doped) samples showed better Li-ion conductivities than the single-doped (Al-doped) samples. The improved Li-ion conductivity of triple (Al/Ga/Ta)-doped LLZO may be attributed to the positive effect of each additional doping element (Ga, Ta) on Al-doped LLZO. Ga had a lower occupancy rate of Li1 sites (24 d Li sites) than Al to reduce the obstacle of Li ion mobility, and also enlarged the lattice for Li ion transport because of its large size. In addition, additional Ta doping can move Al from 24 d to 96 h Li sites (Li2 sites), and thus can provide more pathways and Li vacancies for Li ion movement.

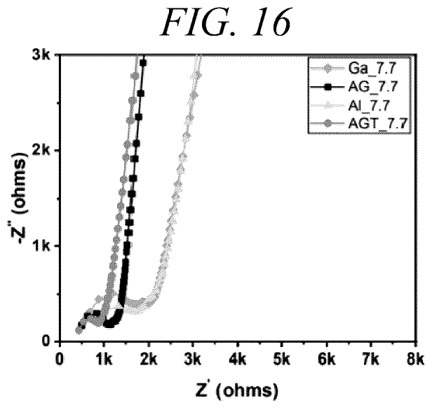

FIG. 16 is Nyquist plots of Al-doped LLZO (Al_7.7), Ga-doped LLZO (Ga_7.7), Al/Ga-doped LLZO (AG_7.7), and Al/Ga/Ta-doped LLZO (AG_7.7) having an initial Li concentration of 7.7 mol according to one embodiment of the present disclosure. Investigations of LLZOs with single and double doping, such as Ga-doped LLZO (Ga_7.7) and Al/Ga-doped LLZO (AG_7.7), were also performed for comparison (FIG. 16 and Table 4), and these showed low ionic conductivities (2.0×10⁻⁴ S·cm⁻¹ and 3.2×10⁻⁴ S·cm⁻¹, respectively) compared to triple (Al/Ga/Ta)-doped AGT_7.7. Table 4 below summarizes the ionic conductivities of Al-doped, Ga-doped, Al/Ga-doped, and Al/Ga/Ta-doped LLZO pellets at room temperature when the initial Li concentration is 7.7 mol.

TABLE 4

| Sample | Al_7.7 | Ga_7.74 | AG_7.7 | AGT_7.7 |
|---|---|---|---|---|
| Ionic conductivity | 1.7 | 2.0 | 3.2 | 3.6 |
| (×10⁻⁴ S · cm⁻¹) | | | | |

FIG. 16 and Table 4 point out that all doping elements play an important role in enhancing the Li-ion conductivities of LLZO. The relative densities of all pellets are presented in Table 3 above and in FIG. 14A.

As shown in Table 3 above and FIG. 14A, low relative density values were observed in the samples prepared with a low initial Li concentration (x=6.9). If the initial Li content is further increased to 7.7 mol, the relative densities are greatly improved. The relative densities of the Al_7.7 and AGT_7.7 samples reached 96.55% and 97.84%, respectively. The relative densities start to decrease with increasing initial Li content (x=8.4), and this is also confirmed in the SEM images of the sintered pellets in FIGS. 10C and 10F. This can be explained by the fact that at high initial Li content, more Li tends to be located in the grain boundary (GB) region and may be easily evaporated in the form of Li₂O vapor, resulting in remaining of gaps and reduction of densities in the samples. This indicates the important role of the initial Li content in the formation of cubic phase LLZO and the relative densities of the pellets.

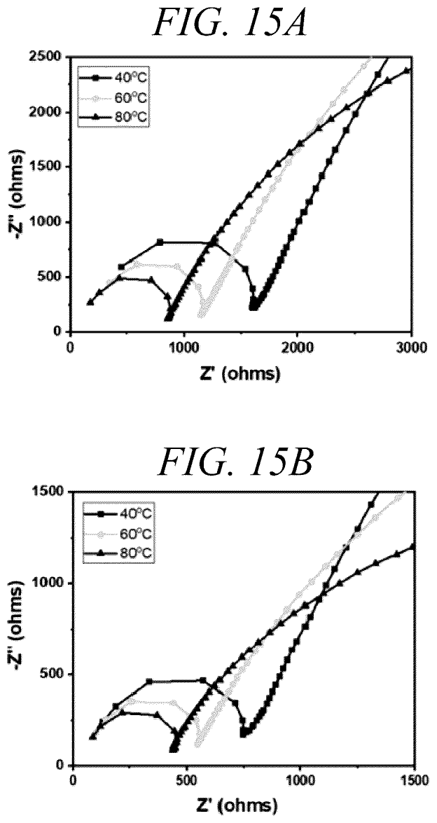

FIG. 14B is Arrhenius plots of an Al-doped sample (Al_7.7) and a triple (Al/Ga/Ta)-doped sample (AGT_7.7) according to one embodiment of the present disclosure. FIGS. 15A and 15B are EIS results of an Al-doped sample (FIG. 15A) and a triple (Al/Ga/Ta)-doped sample (FIG. 15B) having an initial Li concentration of 7.7 mol when the samples according to one embodiment of the present disclosure have different temperatures. The temperature dependence of the ionic conductivities of both of the Al-doped sample and the triple (Al/Ga/Ta)-doped sample is shown as Arrhenius plots in FIG. 14B, and the EIS results when these samples have different temperatures are shown in FIGS. 15A and 15B.

The linear shapes in FIGS. 15A and 15B show no change in the structure and composition of the pellets during measurements in a temperature range of 25 to 80° C. At all temperatures, triple (Al/Ga/Ta)-doped LLZO exhibits higher Li-ion conductivities than Al-doped LLZO. In addition, the activation energy of triple (Al/Ga/Ta)-doped LLZO (0.34 eV) was lower than that of Al-doped LLZO (0.41 eV). This shows an advantage for Li ion transport with low activation energy, which means that triple (Al/Ga/Ta)-doped LLZO has potential for solid battery applications.

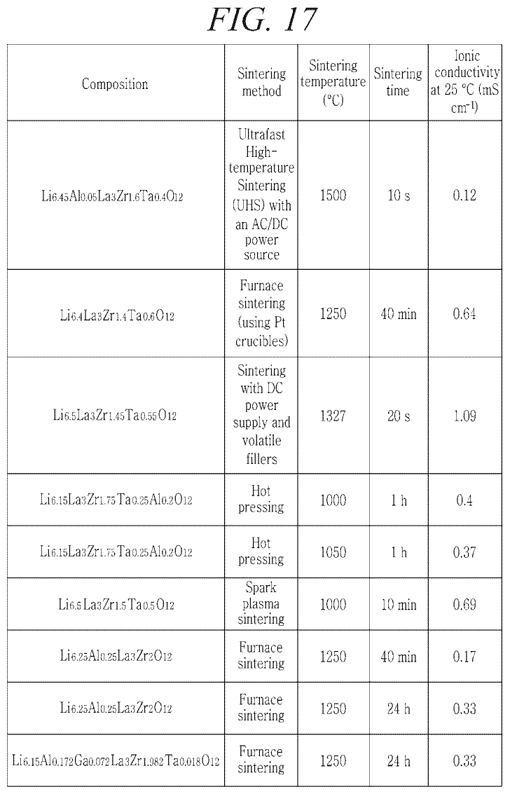

FIG. 17 summarizes a comparison list of rapidly sintered LLZO pellets according to one embodiment of the present disclosure.

Regarding high-speed densification, there are several previous studies applying different advanced methods in order to reduce the duration of the sintering process. A list of rapidly sintered LLZO pellets is summarized in FIG. 17, indicating that most previous work applied complex processes including expensive equipment or consumables to compensate Li loss and phase change during rapid densification. In the conventional art, Al/Ta-doped LLZO pellets were manufactured with AC/DC power and ultrafast high-temperature sintering (UHS), and the sintering temperature reached 1,500° C., but the duration was only 10 seconds, and the most excellent sample showed an ionic conductivity of 0.12 mS·cm⁻¹ and a relative density of 93% at room temperature. In another conventional art, a hot press method was applied at a low temperature)(1,050° C. and a longer time (1 h), and the Li-ion conductivity and density of the pellets were 0.37 mS·cm⁻¹ and 98%, respectively. The spark plasma sintering method was also applied to manufacture LLZO pellets with relatively high ionic conductivity (0.69 mS·cm⁻¹) and relative density (95.5%) at a low temperature)(1,000° C. for a short sintering time (10 minutes). In another conventional art, a high-quality Pt crucible was used for a short sintering process (1,250° C., 40 minutes) in order to reduce the loss of Li, and the final pellets showed high ionic conductivity (0.64 mS·cm⁻¹) and high relative density (95%).

In the present disclosure, the modification of the LLZO components was focused on by adding three different dopants (Al, Ga, and Ta) and controlling the initial Li content while applying a cost-efficient and accessible conventional fabrication process. A sintering furnace was applied at 1,250° C. for a short time (40 minutes), and the ionic conductivity of the best sample (AGT_7.7) was 0.36 mS·cm⁻¹ (see Table 3 above). This sample also has a very high relative density (97.84%) (see Table 3 above), and the cross-sectional SEM image of the pellets shows small closed pores and a surface which is dense in such a degree that a spacing between individual grains may be almost negligible. In addition, the pellets were stabilized with a high ratio of the cubic phase (˜80%) in the structure after sintering (FIGS. 8 and 10). All of the above results show efficient calcination with short duration for good quality LLZO pellets in the present disclosure. The ionic conductivity value of AGT_7.7 can be further improved by optimizing the ratio of doping elements and/or optimizing the sintering process to reduce the grain boundary resistance. In fact, Al-doped LLZO with an initial Li content of 7.7 mol was also prepared with a much longer sintering time (24 h) for particle densification to reduce particle boundary resistance (grain boundary resistance).

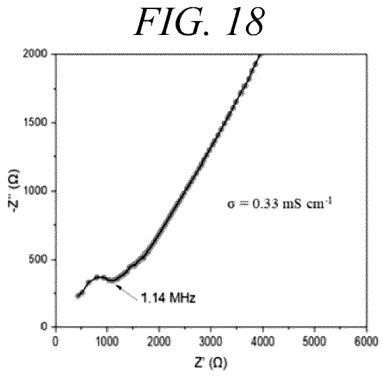

FIG. 18 shows a Nyquist plot of Al-doped LLZO which has an initial Li content of 7.7 mol and is prepared by performing sintering for 24 hours according to one embodiment of the present disclosure. After extending the sintering time, the ionic conductivity of Al_7.7 LLZO was improved (0.33 mS·cm⁻¹ 1), indicating a decrease in particle boundary resistance. Surprisingly, the ionic conductivity of Al_7.7 sintered for 24 hours was still lower than that of sample AGT_7.7 (triple-doped LLZO with Li content of 7.7) sintered for 40 minutes. This indicates that triple doping plays an important role in the manufacture of high-quality LLZO pellets with very short sintering times.

As a result, in the present disclosure, a solid-state LLZO electrolyte was synthesized in a short sintering time with triple doping (Al/Ga/Ta) and an initial Li concentration. The synergistic effects of initial Li content and triple doping on the crystal structure and Li-ion conductivity of LLZO were investigated and compared with Al-doped LLZO. The results showed a phase transition and change in the density of the pellets at different initial Li contents. In addition, effective Li substitution and reduced Li loss were observed in pellets manufactured with triple doping at optimized initial Li concentrations after calcination and sintering, respectively. This shows the importance of initial Li concentration and triple doping in the preparation of LLZO electrolytes with high ionic conductivities. High-quality LLZO pellets with the most excellent ionic conductivity of 3.6×10⁻⁴ S·cm⁻¹ and high relative density (97.8%) were obtained based on such synergistic effects. In addition, it is noteworthy that the percentage of the cubic phase in the crystal structure of LLZO was calculated and the purity of the crystal phase was investigated based on the XRD Rietveld refinement method. Such an approach has hardly been investigated in the previous documents and cannot be specifically provided through XRD patterns alone. Thus, the present disclosure in the field of LLZO not only controls the manufacturing process, but also customizes the phase components of the final product more efficiently, and this can reduce the cost and energy required in research and manufacturing. Furthermore, the present disclosure will be able to contribute to future research related to LLZO electrolytes with high ionic conductivity and a short sintering process.

What is claimed is:

1. A solid electrolyte composition for a triple-doped garnet-type all-solid-state battery, which comprises a Li-based compound, a La-based compound, and a Zr-based compound, and comprises an Al-based compound, a Ga-based compound, and a Ta-based compound for doping.

2. The solid electrolyte composition of claim 1, wherein the Li-based compound included in the Li-based compound, the La-based compound, and the Zr-based compound has a mole fraction of 0.57 or more and 0.63 or less.

3. A method for preparing a solid electrolyte for a triple-doped garnet-type all-solid-state battery, the method comprising:
a mixing step of preparing a mixture by mixing the solid electrolyte composition for a triple-doped garnet-type all-solid-state battery of claim 1;
a calcination step of calcining the mixture; and
a pulverization step of pulverizing the calcined mixture to prepare a pulverized material.

4. The method of claim 3, further comprising:
a compression step of compressing the pulverized material to form it into pellets; and
a sintering step of sintering the pellets.

5. The method of claim 3, wherein the calcination step is performing heat treatment at a temperature of 800° C. or more and 1,000° C. or less for 1 hour or more and 10 hours or less.

6. The method of claim 3, wherein the pulverization step is performing plane surface ball milling at a speed of 200 rpm or more and 500 rpm or less.

7. The method of claim 3, wherein the pulverized material has an average particle size of 0.5 μm or more and 3 μm or less.

8. The method of claim 4, wherein the compression step has a pressure of 100 MPa or more and 300 MPa or less.

9. The method of claim 4, wherein the sintering step is performing heat treatment at a temperature of 1,100° C. or more and 1,300° C. or less for a time of 30 minutes or more and 50 minutes or less.

10. A solid electrolyte for a triple-doped garnet-type all-solid-state battery, which contains Li, La, and Zr and is doped with Al, Ga, and Ta.

11. The solid electrolyte of claim 10, wherein the solid electrolyte for the all-solid-state battery has a structure of the following Formula 1:
LiₐAl_{b}Ga_{c}La₃Zr_{d}TaₑO₁₂ [Formula 1]
in Formula 1, 5.5≤a≤8.0, 0.18≤b≤0.24, 0.06≤c≤0.08, 1.75≤d≤1.90, and 0.01≤e≤0.02.

12. The solid electrolyte of claim 10, wherein the solid electrolyte for the all-solid-state battery has an ionic conductivity of 3.0×10⁻⁴ S·cm⁻¹ or more and 5.0×10⁻⁴ S·cm⁻¹ or less.

13. The solid electrolyte of claim 10, wherein the solid electrolyte for the all-solid-state battery contains a cubic phase and a tetragonal phase, and the cubic phase is contained in an amount of 75% by weight or more and 85% by weight or less.

14. The solid electrolyte of claim 10, wherein the solid electrolyte for the all-solid-state battery has a relative density of 97% or more calculated by Equation 1 below.
Relative density (%)=real density of solid electrolyte for triple-doped garnet-type all-solid-state battery/theoretical density of solid electrolyte for triple-doped garnet-type all-solid-state battery [Equation 1]

15. The solid electrolyte of claim 10, wherein the solid electrolyte for the all-solid-state battery is a powder type or a pellet type.
